(19) United States
(12) Patent Application Publication
(10) Pub. No.: US 2016/0118837 A1
(43) Pub. Date: Apr. 28, 2016

(54) WIRELESS CHARGER DEVICE AND ELECTRONIC DEVICE

(71) Applicant: HON HAI PRECISION INDUSTRY CO., LTD., New Taipei (TW)

(72) Inventor: KUO-HSIANG OU YANG, New Taipei (TW)

(21) Appl. No.: 14/527,277

(22) Filed: Oct. 29, 2014

(30) Foreign Application Priority Data
Oct. 24, 2014 (TW) 103136726

(51) Int. Cl. H02J 7/02; H02J 7/00

(52) U.S. Cl. CPC H02J 7/025; H02J 7/0042; H02J 7/0052

(57) ABSTRACT

A wireless charger device includes a base, an electronic coating film, a printed circuit board, and a connector. The electrical coating film is located on the base and defines a wireless charging circuit for receiving power signal from a charging device. The printed circuit board connects to a rechargeable battery. The connector is electrically connected to the electrical coating film and the printed circuit board. The printed circuit board can charge the rechargeable battery upon receiving the power signal from the electrical coating film.

### CROSS-REFERENCE TO RELATED APPLICATIONS

This application claims priority to Taiwanese Patent Application No. 103136726 filed on Oct. 24, 2014, the contents of which are incorporated by reference herein.

### FIELD

The present invention relates to a wireless charger device and an electronic device with the wireless charger device.

### BACKGROUND

Wireless charging is a method of running an electric current through electromagnetic induction to thereby charge up a rechargeable battery. A magnetic field generated in a first coil of a charging panel is induced to a second coil connected to the rechargeable battery to thereby supply the electric current. Such a wireless charging is usefully applied to portable communication apparatuses, electric vehicles, and so on.

### BRIEF DESCRIPTION OF THE DRAWINGS

Implementations of the present technology will now be described, by way of example only, with reference to the attached figures.

FIG. 1 is a diagrammatic view of an embodiment of two electronic devices charging through a charging device.

FIG. 2 is an exploded, isometric view of one of electronic devices of FIG. 1.

FIG. 3 is an assembled, isometric view of the electronic device of FIG. 2.

FIG. 4 is an exploded, isometric view of a wireless charger device of one of electronic devices of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

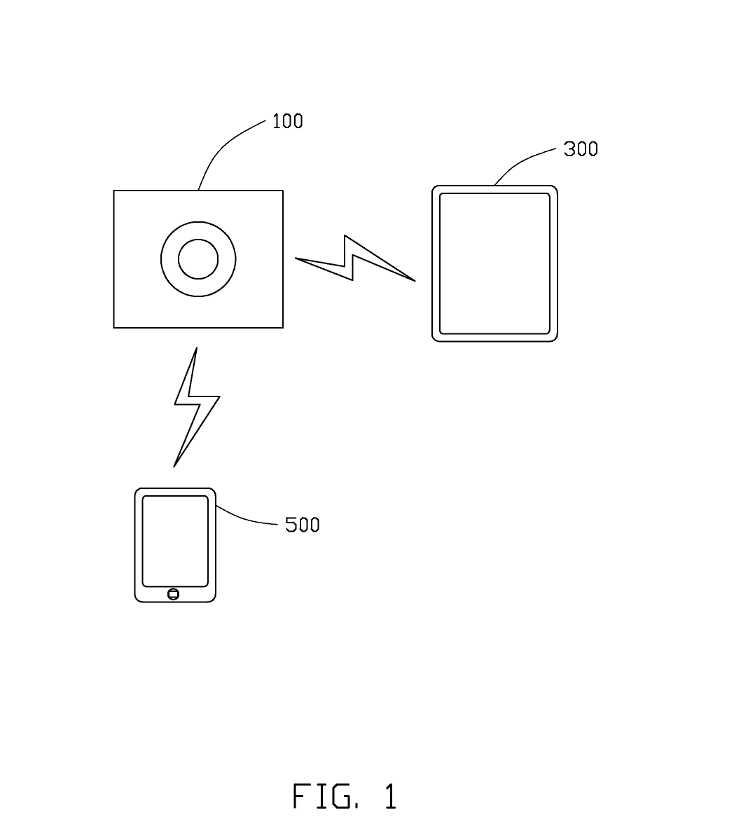

FIG. 1 illustrates two electronic devices in accordance with an embodiment. The two electronic devices can include a first electronic device 300 and a second electronic device 500. The two electronic devices can be charged by a wireless charging device 100. The first electronic device 100 and the second electronic device 500 can be a smart phone, a tablet computer, or a laptop computer, and so on.

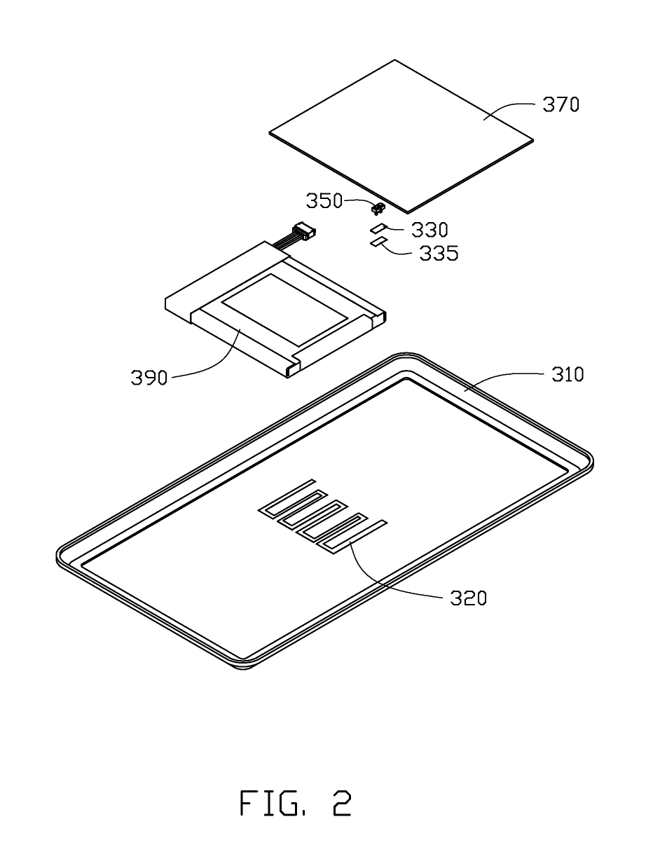

FIG. 2 illustrates the first electronic device 300 in one embodiment. The electronic device 300 can include an enclosure 310, an electrical coating film 320, a connector 350, a printed circuit board 370, and a rechargeable battery 390. The enclosure 310 can include a grass substrate or an acrylic substrate. The electrical coating film 320 is coated on an inner side of the enclosure 310. The electrical coating film 320 can be an indium tin oxide (ITO) film. The ITO film can be deposited on surface of the enclosure 310 by Physical Vapor Deposition (PVD) or Chemical Vapor Deposition (CVD). A thickness of the ITO film is about 0.7 millimeter. After the ITO film is coated on the enclosure 310, the ITO film can be etched to form a wireless charging circuit to receive the wireless power signal from the charging device 100.

The connector 350 can include a pogo pin. The pogo pin is used in electronics to establish a connection between two printed circuit boards. The pogo pin usually takes the form of a slender cylinder containing two sharp, spring-loaded pins. When pressed between two electronic circuits, the sharp points at each end of the pogo pin make secure contacts with the two circuits and thereby connect them together. The connector 350 is electrically coupled to the electrical coating film 320.

The first electronic device 300 can further include a flexible contact 330 for buffering contact of the connector 350. The flexible contact 330 is attached to the electrical coating film 320 through an anisotropic conductive adhesive 335. The connector 350 electrically abuts the flexible contact 330. The flexible contact 330 can prevent direct contact of the connector 350 and the electrical coating film 320 to avoid scratching the electrical coating film 320.

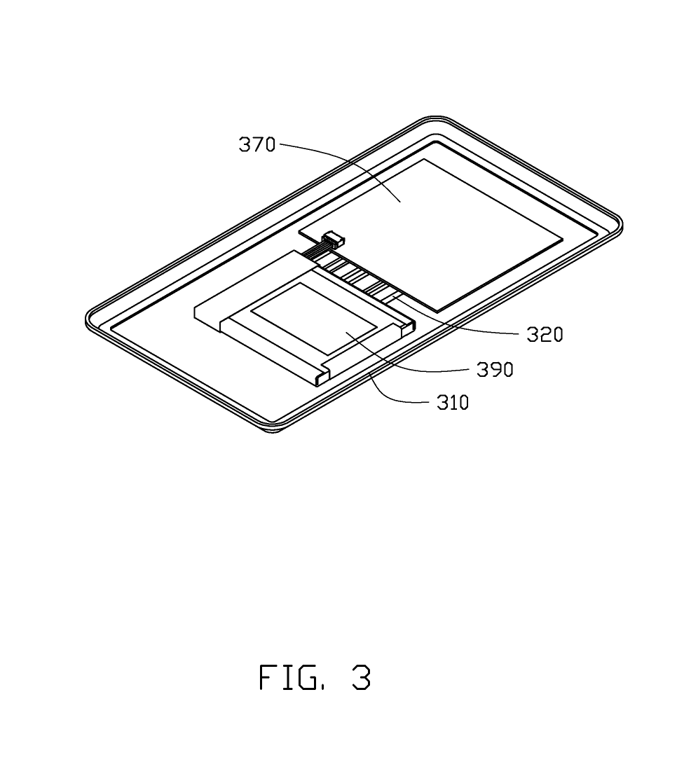

FIG. 3 also illustrates the first electronic device 300 in one embodiment. The printed circuit board 370 can contact the connector 350 and is coupled to the rechargeable battery 390. The electrical coating film 320 can receive power signal from the charging device 100 and transmit power to the printed circuit board 370 through the connector 350. The printed circuit board 370 can charge the rechargeable battery 390 or supply to a system of the first electronic device 300.

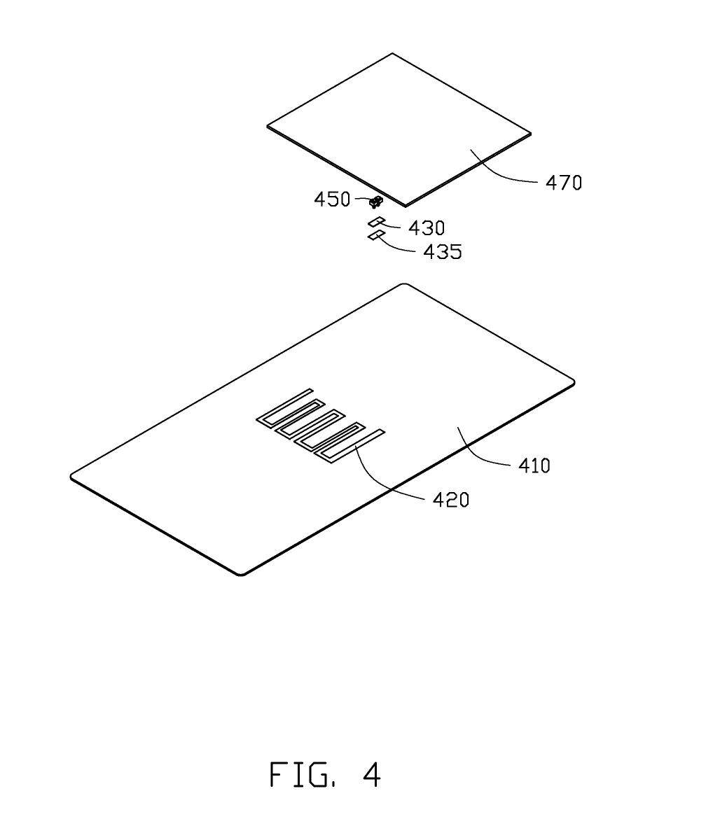

FIG. 4 illustrates the second electronic device 500 in another embodiment. A wireless charger device 400 can be integrated or removably mounted to the second electronic device 500. The wireless charger device 400 can receive power signal from the charging device 100 and charge second electronic device 500. The wireless charger device 400 can include a base 410, an electrical coating film 420, a connector 450, a printed circuit board 470. The base 410 can include a grass substrate or an acrylic substrate. The electrical coating film 420 is coated on an inner side of the base 410. The electrical coating film 420 can be an indium tin oxide (ITO) film. The ITO film can be deposited on surface of the base 410 by Physical Vapor Deposition (PVD) or Chemical Vapor Deposition (CVD). A thickness of the ITO film is about 0.7 millimeter. After the ITO film is coated on the base 410, the ITO film can be etched to form a wireless charging circuit to receive the wireless power signal from the charging device 100.

The connector 450 can include a pogo pin. The connector 450 is electrically coupled to the electrical coating film 420.

The wireless charger device 400 can further include a flexible contact 430 for buffering contact of the connector 450. The flexible contact 430 is attached to the electrical coating film 420 through an anisotropic conductive adhesive 435. The connector 450 electrically abuts the flexible contact 430. The flexible contact 430 can prevent direct contact of the connector 450 and the electrical coating film 420 to avoid scratching the electrical coating film 420.

The printed circuit board 470 can contact the connector 450 and is coupled to the rechargeable battery. The electrical coating film 420 can receive power signal from the charging device 100 and transmit power to the printed circuit board 470 through the connector 450. The printed circuit board 470 can charge the rechargeable battery or supply to a system of the second electronic device 500.

The embodiments shown and described above are only examples. Many details are often found in the art such as the other features of a wireless charger device and electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A wireless charger device for charging a rechargeable battery comprising:
a base;
an electrical coating film located on the base and defining a wireless charging circuit for receiving power signal from a charging device;
a printed circuit board connecting to the rechargeable battery; and
a connector electrically connecting to the electrical coating film and the printed circuit board,
wherein the printed circuit board is configured to charge the rechargeable battery upon receiving the power signal from the electrical coating film.

2. The wireless charger device of claim 1, wherein the base comprises a grass substrate.

3. The wireless charger device of claim 1, wherein the base comprises an acrylic substrate.

4. The wireless charger device of claim 1, wherein the electrical coating film is an indium tin oxide film.

5. The wireless charger device of claim 4, wherein a thickness of the indium tin oxide film is about 0.7 millimeter.

6. The wireless charger device of claim 1, further comprising a flexible contact, wherein the flexible contact is attached to the electrical coating film through an anisotropic conductive adhesive, and the connector electrically abuts the flexible contact.

7. The wireless charger device of claim 1, wherein the connector is a POGO pin.

8. The wireless charger device of claim 1, wherein the wireless charging circuit is etched on the electrical coating film.

9. An electronic device comprising:
an enclosure;
a rechargeable battery located in the enclosure;
an electrical coating film located on the enclosure and defining a wireless charging circuit for receiving power signal from a charging device;
a printed circuit board connecting to the rechargeable battery; and
a connector electrically connecting to the electrical coating film and the printed circuit board,
wherein the printed circuit board is configured to charge the rechargeable battery upon receiving the power signal from the electrical coating film.

10. The electronic device of claim 9, wherein the enclosure comprises a grass substrate.

11. The electronic device of claim 9, wherein the enclosure comprises an acrylic substrate.

12. The electronic device of claim 9, wherein the electrical coating film is an indium tin oxide film.

13. The electronic device of claim 12, wherein a thickness of the indium tin oxide film is about 0.7 millimeter.

14. The electronic device of claim 9, further comprising a flexible contact, wherein the flexible contact is attached to the electrical coating film through an anisotropic conductive adhesive, and the connector electrically abuts the flexible contact.

15. The electronic device of claim 9, wherein the connector is a POGO pin.

16. The electronic device of claim 9, wherein the wireless charging circuit is etched on the electrical coating film.

17. A wireless charger device for recharging a rechargeable battery, comprising:
a base;
an electrical coating film positioned on the base, the electrical coating film defining a wireless charging circuit;
a printed circuit board connectable to a rechargeable battery; and
a connector electrically connecting the electrical coating film to the printed circuit board;
wherein, the wireless charging circuit defined by the electrical coating film is configured to wirelessly receive a power signal from a wireless charging device and the printed circuit board is configured to receive the power signal from the electrical coating film and provide power to the connected rechargeable battery.

18. The wireless charger device of claim 17, wherein the base comprises a grass substrate.

19. The wireless charger device of claim 17, wherein the electrical coating film is an indium tin oxide film.

20. The wireless charger device of claim 17, wherein the connector is a POGO pin.
